(19) United States
(12) Patent Application Publication
(10) Pub. No.: US 2019/0026840 A1
(43) Pub. Date: Jan. 24, 2019

(54) Method and System for Providing Real-Time Visual Information Based on Financial Flow Data

(71) Applicant: Zhouyi TANG, Beijing (CN)

(72) Inventor: Zhouyi TANG, Beijing (CN)

(21) Appl. No.: 16/028,035

(22) Filed: Jul. 5, 2018

(30) Foreign Application Priority Data
Jul. 19, 2017 (CN) 201710588804.1

(51) Int. Cl. G06Q 40/00; G06F 17/30; G06T 11/20; G06K 9/62; G06F 15/18

(52) U.S. Cl. CPC G06Q 40/125; G06F 17/30601; G06F 15/18; G06K 9/6263; G06T 11/206

(57) ABSTRACT

The present application relates to a method and a system for providing real-time visual information based on financial flow data. The system comprises: an input data operation module, configured to input data; a data cleaning module, configured to process and verify the data input by the input data operation module; a labeling module, configured to label the data processed and verified by the data cleaning module through a big data deep learning method; and a data visualization module, configured to visualize the data labeled by the labeling module. Through the big data processing method, the financial data processing time is saved, and the processing accuracy is improved at the same time; historical data can be effectively processed, the data that has been put into a database can be optimized, and visual information can be provided for corporate managers quickly in real time.

### CROSS-REFERENCES TO RELATED APPLICATIONS

This application claims the priority of Chinese patent application No. 201710588804.1, filed on Jul. 19, 2017, the entirety of which is incorporated herein by reference.

### FIELD OF THE INVENTION

The present application relates to the field of corporate data analysis and visualization, and particularly, relates to a method and a system for providing real-time visual information based on financial flow data.

### BACKGROUND OF THE INVENTION

In the prior art, we usually attempt to deal with corporate financial flow through NLP (Natural Language Processing) word segmentation and machine learning methods in financial processing of corporates to form a solution of three accounting statements. This processing method has the following deficiencies: starting from auxiliary accounting, NLP word segmentation and other processing are performed on the basis of each accounting data, so the method is not a big data processing method which aim is to save the accounting time or improve the precision; historical data cannot be effectively processed, and the algorithm update cannot optimize the data that has been put into a database.

### SUMMARY OF THE INVENTION

The essence of defining a corporate strategy in the present application is a relationship between a corporation (actual controller) and a few roles, and the relationship can be described commercially in terms of cash (capital) flow. The present application realizes extraction and visualization of the above corporate strategy from financial flow data, and the visualization is real-time.

In order to solve the above technical problems, the present application provides a method for providing real-time visual information based on financial flow data, including the following steps:

1) inputting data;

2) processing and verifying the data input in step 1);

3) labeling the data processed and verified in step 2) through a big data deep learning method; and

4) visualizing the data labeled in step 3).

In the method for providing real-time visual information based on financial flow data, in which step 1) of inputting data specifically includes the following data input methods: (1) data push; and (2) data extraction.

In the method for providing real-time visual information based on financial flow data, in which step 2) specifically includes:

(1) when the data comes from data push, judging the type of the data, and after the type of the data is judged, arranging the multi-column multi-table data into a csv file including but not limited to date, numbers and texts, hereinafter referred to as “data A”; and when the data A needs to pass the data verifying process, verifying whether the value of at least one of date, numbers and texts conforms to a range or a specification and verifying whether a repeated item is present, so as to obtain a data B file meeting the requirements; and

(2) when the data comes from data extraction, skipping the above stage of forming data A, and directly entering the stage of forming data B.

In the method for providing real-time visual information based on financial flow data, in which step 3) specifically includes: labeling the data B file through a machine learning method of semi-supervised learning or supervised learning, wherein the processed data carries labels of multiple different roles;

the labeling the data B specifically includes: segmenting the text into words, and then labeling the words with semi-supervised learning or supervised learning, wherein the principle of labeling is based on the similarity between sentences and labels;

the similarity between sentences and labels is implemented in such a way that the text is segmented into words, first the number of occurrences of different words in a sentence is calculated to obtain a word frequency vector A, then a word frequency that each word corresponds to different labels is calculated, the word frequencies form word frequency vectors B of the text under different labels, the number of the word frequency vectors B corresponds to the number of the labels, the cosines of the word frequency vector A and the word frequency vectors B are calculated, the similarity is higher if the value is larger, and finally the most similar label is selected;

in order to quickly build a label word frequency library, a sentence similarity method is adopted for batch processing; the sentence similarity is implemented in such a way that the text is segmented into words, these words constitute a union, the word frequencies of words of two sentences in the union are respectively calculated, these frequencies constitute a word frequency vector, the cosine similarity of two vectors is calculated, and the similarity is higher if the value is larger.

In the method for providing real-time visual information based on financial flow data, step 4) specifically includes: expressing the cash flow of six roles including Asset, Client, Partner, Government, Employee and Owner in the form of a visual graph to reflect a corporate decision in real time.

A system for providing real-time visual information based on financial flow data, including:

an input data operation module, configured to input data;
a data cleaning module, configured to process and verify the data input by the input data operation module;
a labeling module, configured to label the data processed and verified by the data cleaning module through a big data deep learning method; and
a data visualization module, configured to visualize the data labeled by the labeling module.

In the system for providing real-time visual information based on financial flow data, the input data operation module includes at least one of a data push module and a data extraction module.

In the system for providing real-time visual information based on financial flow data, the data cleaning module specifically includes a data type judgment module, a data arrangement module and a data verification module, or includes a data type judgment module and a data verification module;

the data type judgment module is configured to judge the type of the data when the data comes from data push;

the data arrangement module is configured to, after the type of the data is judged, arrange the multi-column multi-table data into a csv file including but not limited to data, numbers and texts, hereinafter referred to as “data A”;

the data verification module is configured to, when the data A needs to pass the data verifying process, verify whether the value of at least one of date, numbers and texts conforms to a range or a specification and verifying whether a repeated item is present, so as to obtain a data B file meeting the requirements;

when the data type judgment module determines that the data comes from data extraction, the above stage of forming data A by the data arrangement module is skipped, and the stage of forming data B by the data verification module is directly entered.

In the system for providing real-time visual information based on financial flow data, the labeling module is specifically configured to label the data B file through a machine learning method of semi-supervised learning or supervised learning, wherein the processed data carries labels of multiple different roles;

labeling the data B specifically includes: segmenting the text into words, and then labeling the words with semi-supervised learning or supervised learning, wherein the principle of labeling is based on the similarity between sentences and labels;

the similarity between sentences and labels is implemented in such a way that the text is segmented into words, first the number of occurrences of different words in a sentence is calculated to obtain a word frequency vector A, then a word frequency that each word corresponds to different labels is calculated, the word frequencies form word frequency vectors B of the text under different labels, the number of the word frequency vectors B corresponds to the number of the labels, the cosines of the word frequency vector A and the word frequency vectors B are calculated, the similarity is higher if the value is larger, and finally the most similar label is selected;

in order to quickly build a label word frequency library, a sentence similarity method is adopted for batch processing; the sentence similarity is implemented in such a way that the text is segmented into words, these words constitute a union, the word frequencies of words of two sentences in the union are respectively calculated, these frequencies constitute a word frequency vector, the cosine similarity of two vectors is calculated, and the similarity is higher if the value is larger.

In the system for providing real-time visual information based on financial flow data, the data visualization module is specifically configured to express the cash flow of six roles including Asset, Client, Partner, Government, Employee and Owner in the form of a visual graph to reflect a corporate decision in real time.

In the present application, through the big data processing method, the financial data processing time is saved, and the processing accuracy is improved at the same time;

historical data can be effectively processed, the data that has been put into a database can be optimized, and visual information can be provided for corporate managers quickly in real time.

### BRIEF DESCRIPTION OF THE DRAWINGS

FIG. 1 is a schematic diagram of a label processing flow of the present application.

FIG. 2 is a schematic diagram of a first-level label of the present application.

FIG. 3 is a schematic diagram of an overall structure of a system of the present application.

FIG. 4 is a schematic hardware diagram of a system of the present application.

### DETAILED DESCRIPTION OF THE EMBODIMENTS

The present application will be further described in detail below in combination with the accompanying drawings. It is necessary to point out here that the following specific embodiments are used only for further description of the present application and are not intended to limit the protection scope of the present application. Some non-essential improvements and adjustments may be made to the present application by those skilled in the art according to the content of the present application.

First, we define that a corporation is a means to change one form of cash flow into the other more effective form of cash flow under modern monetary system, and such cash flow is embodied by the cash flow between a corporation and a few roles.

In our opinion, these roles are respectively Asset, Client, Partner, Government, Employee and Owner. Through the division of the six roles, the division of cash flow does not have the possibility of attribution overlap, and the effectiveness of cash can also be better reflected.

Asset: including but not limited to owned investments, fixed assets, cash and cash equivalents.

Client: including but not limited to objects using corporate services or products.

Partner: including but not limited to corporate upstream and downstream industry chains.

Government: all cash flows with the government, including but not limited to taxes and state subsidies.

Employee: all cash flows with the employee, including but not limited to employee salaries.

Owner: the object which can determine corporate strategies and cash flow.

In the cash flow among the six roles, there are two forms of income and expenditure. We believe the two forms do not counteract each other, but should be calculated separately. The measurement is the transaction scale between the roles, not the difference.

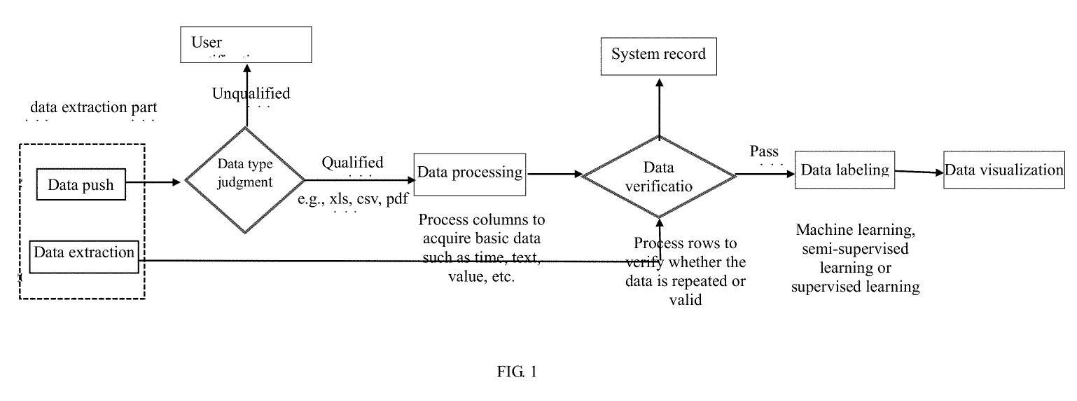

Data of financial flow and the like is converted into a visual corporate strategy through a big data deep learning method. FIG. 1 is a schematic diagram of a label processing flow of the present application.

After financial data is input, the data is processed and verified, and the cleaned data is labeled via a big data deep learning method, wherein the labels include the above six roles.

At present, data comes from two forms, which are respectively data push and data extraction. When the data comes from data push, the data type needs to be judged. The data types that can be judged at present include but are not limited to xls, csv, jpg and pdf. After the judgment, the multi-column multi-table data is arranged into a csv file including but not limited to date, numbers and texts (hereinafter referred to as “data A”). The data A needs to pass the data verifying process. Whether the value of at least one of data, numbers and texts conforms to a range or a specification and whether a repeated item is present are verified, so as to obtain a data B file meeting the requirements. The data B file is labeled through a machine learning method of semi-supervised learning or supervised learning, and the processed data carries one label of the above six roles. Finally, the cash transactions of the six roles are expressed with a visual graph to reflect a corporate decision in real time.

When the data comes from data extraction, the above stage of forming data A is skipped and the stage of forming data B is directly entered.

The data B is labeled using the method of segmenting the text into words and then labeling the words with semi-supervised learning or supervised learning, wherein the principle of labeling is based on the similarity between sentences and labels.

The similarity between sentences and labels is implemented in such a way that the text is segmented into words, first, the number of occurrences of different words in a sentence is calculated to obtain a word frequency vector A, then a word frequency that each word corresponds to different labels is calculated, the word frequencies form word frequency vectors B of the text under different labels (the number of the word frequency vectors B corresponds to the number of the labels), the cosines of the word frequency vector A and the word frequency vectors B are calculated, the similarity is higher if the value is larger, and finally the most similar label is selected.

In order to quickly build a label word frequency library, sentence similarity can be adopted for batch processing. (For example, one piece of data equates to 20 pieces of similar data).

The sentence similarity is implemented in such a way that the text is segmented into words, these words constitute a union, the word frequencies of words of two sentences in the union are respectively calculated, these frequencies constitute a word frequency vector, the cosine similarity of two vectors is calculated, and the similarity is higher if the value is larger.

For example, sentence 1: special tariff import, and sentence 2: normal tariff export;

Word segment in Sentence 1: special/tariff/import, and word segment in sentence 2: normal/tariff/export;

Word union: [special/tariff/import/normal/export]

Calculating word frequencies: word frequency vector of sentence 1:[1,1,1,0,0]; word frequency vector of sentence 2: [0,1,0,1,1]

Calculate the cosine similarity of the two word frequencies, wherein the similarity is higher if the value is larger.

In the present invention, the accuracy of machine learning is directly related to the word frequency library of labels. With the word frequency library increasing, the number of word frequency samples available for machine reference increases, so that the frequencies are more accurate, and the correlation between more data and labels can be analyzed more accurately, therefore the deviation is reduced and the accuracy is improved.

Meanwhile, the labeling process involves a process of interacting with the user. In this process, the user may label the words that are not in the label library or are inadequate for judgment, thus improving the richness and accuracy of the word frequency library and also improving the labeling accuracy.

Visualization of the financial data is completed so far.

When corporate decision makers see the visual real-time cash flow, it can help the decision makers to get rid of the constraints of professional financial languages, and timely and intuitively shows the truth of funds and resources flowing among different roles such as asset, client, partner, government and the like. It helps them to verify the difference between the strategy and the actual implementation, so as to carry out dynamic tracking and adjustment.

When the data gradually increases, the judgment accuracy of the system on data labels is gradually improved due to the machine learning. For each piece of new data, its label accuracy is improved.

A similar method and a variation method: the data is processed with keywords instead of machine learning. For example, the keywords for the label “employee” include: salary, welfare, bonus, etc., then the keyword labeling method is to identify the keywords such as “salary”, “welfare”, “bonus” and the like in the text, i.e., the data is assigned to “employee”.

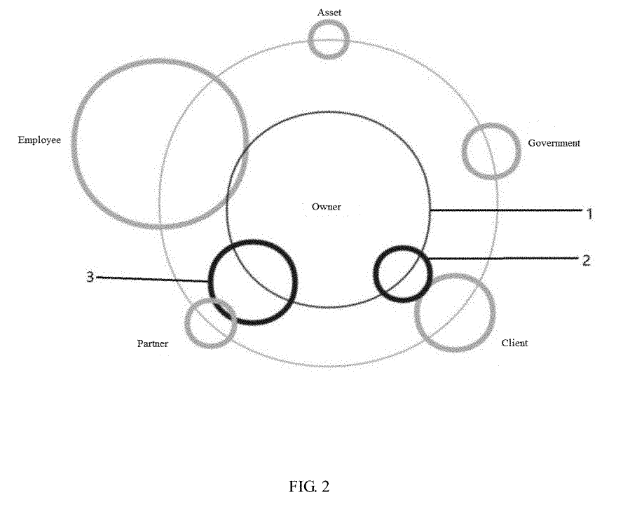

FIG. 2 is a schematic diagram of first-level labels of the present application.

Cash only flows among Asset, Client, Partner, Government, Employee and Owner. “Cannot counteract each other” means that, for example, the cash flow with a partner includes expenditure and income. If the expenditure is 1,000,000 and the income is 800,000, what we focus on is their trade scale 1,800,000, not a loss 200,000.

In the schematic diagram of the first-level labels, red represents income, and blue represents expenditure. As shown in FIG. 2, 1, 2, and 3 are red, and the rest are blue. The cash flow with the partner is reflected in two circles, red 800,000 and blue 1,000,000. We focus on the trade scale 1,800,000, but do not calculate the loss of 200,000. The red circle represents income, and the blue circle represents expenditure. If the circle is larger, the amount is larger (if the area is larger, the amount is larger).

In theory, each of the six roles has its own income and expenditure. The circle in each direction represents the financial status of this role.

The time axis above: we can drag the start time and the end time of data. As the set time changes, the amount of money of each role changes, and the corresponding circle representing the amount of money also changes.

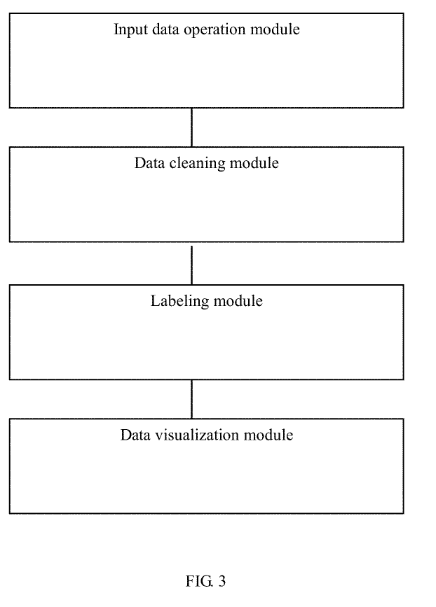

The present application proposes a system for providing real-time visual information based on financial flow data according to the above operation method, as shown in FIG. 3, which is a schematic diagram of an overall structure of the system of the present application, the system includes:

an input data operation module, configured to input data;
a data cleaning module, configured to process and verify the data input by the input data operation module;
a labeling module, configured to label the data processed and verified by the data cleaning module through a big data deep learning method; and
a data visualization module, configured to visualize the data labeled by the labeling module.

In the system for providing real-time visual information based on financial flow data, the input data operation module includes at least one of a data push module and a data extraction module.

In the system for providing real-time visual information based on financial flow data, the data cleaning module specifically includes a data type judgment module, a data arrangement module and a data verification module, or includes a data type judgment module and a data verification module;

the data type judgment module is configured to judge the type of the data when the data comes from data push;

the data arrangement module is configured to, after the type of the data is judged, arrange the multi-column multi-table data into a csv file including but not limited to date, numbers and texts, hereinafter referred to as “data A”;

the data verification module is configured to, when the data A needs to pass the data verifying process, verify whether the value of at least one of date, numbers and texts conforms to a range or a specification and verify whether a repeated item is present, so as to obtain a data B file meeting the requirements;

when the data type judgment module determines that the data comes from data extraction, the above stage of forming data A by the data arrangement module is skipped, and the stage of forming data B by the data verification module is directly entered.

In the system for providing real-time visual information based on financial flow data, the labeling module is specifically configured to label the data B file through a machine learning method of semi-supervised learning or supervised learning, wherein the processed data carries labels of multiple different roles;

Labeling the data B specifically includes: segmenting the text into words, and then labeling the words with semi-supervised learning or supervised learning, wherein the principle of labeling is based on the similarity of sentences and labels;

The similarity between sentences and labels is implemented in such a way that the text is segmented into words, first the number of occurrences of different words in a sentence is calculated to obtain a word frequency vector A, then a word frequency that each word corresponds to different labels is calculated, the word frequencies form word frequency vectors B of the text under different labels, the number of the word frequency vectors B corresponds to the number of the labels, the cosines of the word frequency vector A and the word frequency vectors B are calculated, the similarity is higher if the value is larger, and finally the most similar label is selected;

In order to quickly build a label word frequency library, a sentence similarity method is adopted for batch processing; the sentence similarity is implemented in such a way that the text is segmented into words, these words constitute a union, the word frequencies of words of two sentences in the union are respectively calculated, these frequencies constitute a word frequency vector, the cosine similarity of two vectors is calculated, and the similarity is higher if the value is larger.

In the system for providing real-time visual information based on financial flow data, the data visualization module is specifically configured to express the cash flow of six roles including Asset, Client, Partner, Government, Employee and Owner in the form of a visual graph to reflect a corporate decision in real time.

In the present application, through the big data processing method, the financial data processing time is saved, and the processing accuracy is improved at the same time; historical data can be effectively processed, the data that has been put into a database can be optimized, and visual information can be provided for corporate managers quickly in real time.

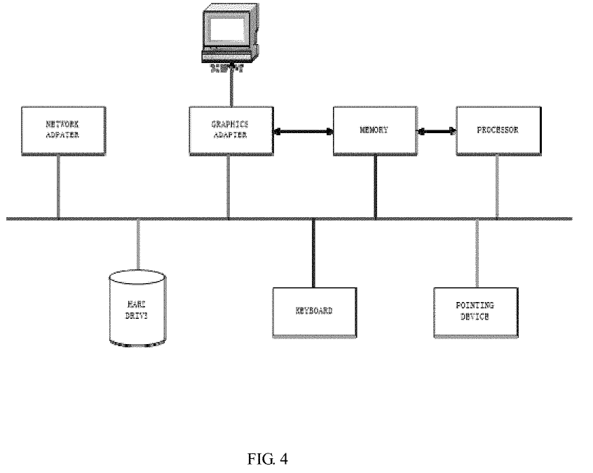

FIG. 4 is a schematic diagram of an exemplary system. As shown in FIG. 4, the system includes a network adapter, a hard drive, a keyboard, a pointing device, a memory, a processor, a graphics adapter, and a display. The display is connected to the graphics adapter, and the processor, memory, and graphics adapter are connected such that the processor may execute certain programs in the memory to implement the disclosed methods.

1. A method for providing real-time visual information based on financial flow data, comprising the following steps:
1) inputting data;
2) processing and verifying the data input in step 1);
3) labeling the data processed and verified in step 2) through a big data deep learning method; and
4) visualizing the data labeled in step 3).

2. The method for providing real-time visual information based on financial flow data according to claim 1, wherein the data inputting in the step 1) specifically comprises the following data input methods: (1) data push; and (2) data extraction.

3. The method for providing real-time visual information based on financial flow data according to claim 2, wherein step 2) specifically comprises:
(1) when the data comes from the data push, judging the type of the data, and after the type of the data is judged, arranging the multi-column multi-table data into a csv file comprising but not limited to date, numbers and texts, hereinafter referred to as “data A”; and when the data A needs to pass the data verifying process, verifying whether the value of at least one of date, numbers and texts conforms to a range or a specification and verifying whether a repeated item is present, so as to obtain a data B file meeting requirements; and
(2) when the data comes from data extraction, skipping the above stage of forming data A, and directly entering the stage of forming data B.

4. The method for providing real-time visual information based on financial flow data according to claim 3, wherein step 3) specifically comprises: labeling the data B file through a machine learning method of semi-supervised learning or supervised learning, wherein the processed data carries labels of multiple different roles;
labeling the data B specifically comprises: segmenting the text into words, and then labeling the words with semi-supervised learning or supervised learning, wherein the principle of labeling is based on the similarity between sentences and labels;
the similarity between sentences and labels implemented in such a way that the text is segmented into words, first, the number of occurrences of different words in a sentence is calculated to obtain a word frequency vector A, then a word frequency that each word corresponds to different labels is calculated, the word frequencies form word frequency vectors B of the text under different labels, the number of the word frequency vectors B corresponds to the number of the labels, the cosines of the word frequency vector A and the word frequency vectors B are calculated, the similarity is higher if the value is larger, and finally the most similar label is selected;
in order to quickly build a label word frequency library, adopting a sentence similarity method for batch processing; the sentence similarity implemented in such a way that the text is segmented into words, these words constitute a union, the word frequencies of words of two sentences in the union are respectively calculated, these frequencies constitute a word frequency vector, the cosine similarity of two vectors is calculated, and the similarity is higher if the value is larger.

5. The method for providing real-time visual information based on financial flow data according to claim 3, wherein step 4) specifically comprises: expressing the cash flow of six roles comprising Asset, Client, Partner, Government, Employee and Owner in the form of a visual graph to reflect a corporate decision in real time.

6. A system for providing real-time visual information based on financial flow data, comprising:
an input data operation module, configured to input data;
a data cleaning module, configured to process and verify the data input by the input data operation module;
a labeling module, configured to label the data processed and verified by the data cleaning module through a big data deep learning method; and
a data visualization module, configured to visualize the data labeled by the labeling module.

7. The system for providing real-time visual information based on financial flow data according to claim 6, wherein the input data operation module comprises at least one of a data push module and a data extraction module.

8. The system for providing real-time visual information based on financial flow data according to claim 7, wherein the data cleaning module specifically comprises a data type judgment module, a data arrangement module and a data verification module, or comprises a data type judgment module and a data verification module;
the data type judgment module is configured to judge the type of the data when the data comes from data push;
the data arrangement module is configured to, after the type of the data is judged, arrange the multi-column multi-table data into a csv file comprising but not limited to date, numbers and texts, hereinafter referred to as “data A”;
the data verification module is configured to, when the data A needs to pass the data verifying process, verify whether the value of at least one of data, numbers and texts conforms to a range or a specification and verify whether a repeated item is present, so as to obtain a data B file meeting the requirements;
when the data type judgment module determines that the data comes from data extraction, the above stage of forming data A by the data arrangement module is skipped, and the stage of forming data B by the data verification module is directly entered.

9. The system for providing real-time visual information based on financial flow data according to claim 8, wherein the labeling module is specifically configured to label the data B file through a machine learning method of semi-supervised learning or supervised learning, wherein the processed data carries labels of multiple different roles;
labeling the data B specifically comprises: segmenting the text into words, and then labeling the words with semi-supervised learning or supervised learning, wherein the principle of labeling is based on the similarity between sentences and labels;
the similarity between sentences and labels implemented in such a way that the text is segmented into words, first the number of occurrences of different words in a sentence is calculated to obtain a word frequency vector A, then a word frequency that each word corresponds to different labels is calculated, the word frequencies form word frequency vectors B of the text under different labels, the number of the word frequency vectors B corresponds to the number of the labels, the cosines of the word frequency vector A and the word frequency vectors B are calculated, the similarity is higher if the value is larger, and finally the most similar label is selected;
in order to quickly build a label word frequency library, a sentence similarity method is adopted for batch processing; the sentence similarity implemented in such a way that the text is segmented into words, these words constitute a union, the word frequencies of words of two sentences in the union are respectively calculated, these frequencies constitute a word frequency vector, the cosine similarity of two vectors is calculated, and the similarity is higher if the value is larger.

10. The system for providing real-time visual information based on financial flow data according to claim 9, wherein the data visualization module is specifically configured to express the cash flow of six roles comprising Asset, Client, Partner, Government, Employee and Owner in the form of a visual graph to reflect a corporate decision in real time.
